(19) United States
(12) Patent Application Publication
(10) Pub. No.: US 2025/0260857 A1
(43) Pub. Date: Aug. 14, 2025

(54) Content System with Related Segment Feature

(71) Applicant: Roku, Inc., San Jose, CA (US)

(72) Inventors: Katherine Marie Ricci, Abington, PA (US); Nicholas George Alexandres, Playa Vista, CA (US); Snehal Karia, Fremont, CA (US)

(21) Appl. No.: 18/441,377

(22) Filed: Feb. 14, 2024

(51) Int. Cl. H04N 21/266; H04N 21/232; H04N 21/442

(52) U.S. Cl. CPC H04N 21/26603; H04N 21/232; H04N 21/442

(57) ABSTRACT

In one aspect, an example method includes: (i) proximate a time period during which a current segment of media content is output for presentation by a content-presentation device, detecting an occurrence of a trigger event; (ii) responsive to detecting the occurrence of the trigger event, obtaining related segment metadata associated with one or more related segments of media content that are separate from, but contextually related to, the current segment; and (iii) proximate a time point at which the trigger event occurred, causing the obtained related segment metadata to be output for presentation.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes: (i) proximate a time period during which a current segment of media content is output for presentation by a content-presentation device, detecting an occurrence of a trigger event; (ii) responsive to detecting the occurrence of the trigger event, obtaining related segment metadata associated with one or more related segments of media content that are separate from, but contextually related to, the current segment; and (iii) proximate a time point at which the trigger event occurred, causing the obtained related segment metadata to be output for presentation.

In another aspect, an example computing system is disclosed. The computing system is configured for performing a set of acts that includes: (i) proximate a time period during which a current segment of media content is output for presentation by a content-presentation device, detecting an occurrence of a trigger event; (ii) responsive to detecting the occurrence of the trigger event, obtaining related segment metadata associated with one or more related segments of media content that are separate from, but contextually related to, the current segment; and (iii) proximate a time point at which the trigger event occurred, causing the obtained related segment metadata to be output for presentation.

In another aspect, an example non-transitory computer-readable medium is disclosed. The computer-readable medium has stored thereon program instructions that upon execution by a computing system, cause performance of a set of acts that includes: (i) proximate a time period during which a current segment of media content is output for presentation by a content-presentation device, detecting an occurrence of a trigger event; (ii) responsive to detecting the occurrence of the trigger event, obtaining related segment metadata associated with one or more related segments of media content that are separate from, but contextually related to, the current segment; and (iii) proximate a time point at which the trigger event occurred, causing the obtained related segment metadata to be output for presentation.

### BRIEF DESCRIPTION OF THE DRAWINGS

FIG. 1 is a simplified block diagram of an example content system in which various described principles can be implemented.

FIG. 2 is a simplified block diagram of an example computing system in which various described principles can be implemented.

FIG. 3 is a depiction of a media content item having multiple segments.

FIG. 4 is a depiction of an example output of related segment metadata.

FIG. 5 is a flow chart of an example method.

FIG. 6 is a flow chart of another example method.

FIG. 7 is a flow chart of another example method.

### DETAILED DESCRIPTION

### I. Overview

As a user watches a movie, it can sometimes be challenging for the user to keep track of everything that happens in the movie. This can sometimes cause the user to be confused while watching certain parts of the movie, namely ones that relate back to earlier parts of the movie.

For example, consider a two-hour movie which includes two scenes early in the movie that relate to a particular plot point, but where that plot point isn't revisited again until a scene towards the end of the movie. Even if the user watches the movie from beginning to end, when the user gets to the later scene, the user may have forgotten what happened in the earlier scenes, and as a result, the user may be confused and/or may not fully appreciate the significance of what is happening in the later scene. This can result in the user having a poor user experience.

These and similar situations can come up in connection with other instances and types of media content as well. For example, consider a television show that includes many episodes over many seasons. When a user is watching a given episode in a later season, there may be events from episodes in earlier seasons that the user watched, but that the user watched a long time ago, perhaps several years ago or longer. Because the user may not remember what happened in those earlier season episodes, this can result in the user being confused and/or not fully appreciating the significance of what is happening in that later season episode. As with the movie example, this can result in the user having a poor viewing experience.

Disclosed herein are systems and corresponding methods to help address these and other issues. According to one aspect of the disclosure, a content system includes a content manager that can obtain media content from a content database and can determine that one or more segments of the media content relate (i.e., contextually relate) to one or more other segments of the media content. Then, for a given segment where it is determined that one or more other segments relate to it, the content manager can generate related segment metadata to indicate this, and store it in association with the given segment, such as in the content database.

After the related segment metadata has been generated and stored, the content system (and/or components thereof, such as a television or other content-presentation device) can perform one or more operations related to obtaining and outputting the related segment metadata. In one aspect, this can involve, proximate a time period during which a current segment of media content is output for presentation by the content-presentation device, the content-presentation device detecting an occurrence of a trigger event (e.g., an event of a user pausing the media content or the detection of a frame marker).

Next, responsive to detecting the occurrence of the trigger event, the content-presentation device can obtain related segment metadata associated with one or more related segments of media content that are separate from, but contextually related to, the current segment. And then, proximate a time point at which the trigger event occurred, the content-presentation device can cause the obtained related segment metadata to be output for presentation, to the user.

The obtained related segment metadata can include various components and can be presented in various ways. For example, the obtained related segment metadata can include a link to media data representing at least one of the one or more related segments, a text-based summary of at least one of the one or more related segments, and/or an image of a character included in at least one of the one or more related segments, among numerous other possibilities. In some examples, the related segment metadata can be presented in a grid-like fashion, with each row corresponding to a different related segment, for easy traversal and review by a user.

In practice, in accordance with one example implementation, this can allow a user to pause media content while watching a current segment, and in response be provided with related segment metadata for one or more related segments, such that the user can select an appropriate link and easily view the related segments and/or read about the related segments, which can aid in providing the user with appropriate context for the current segment.

Thus, returning to the example above in which the user is watching a two-hour movie which includes two scenes earlier in the movie that relate to a particular plot point, but where that plot point isn't revisited again until a scene at the end of the movie, by implementing at least some of the disclosed techniques, proximate the time point that the later scene is to be output, the user can pause the media content, which can result in the content-presentation device obtaining and presenting related segment metadata for each of the earlier scenes in the movie, which can aid in providing the user with appropriate context for the later scene in the movie that the user is about to watch. The same or similar techniques can likewise be applied in other scenarios as well, such in connection with the television episode example discussed above. Many other use cases are possible as well. For example, the disclosed techniques can be used to identify and perform associated operations in connection with related segments across different various different types and/or instances of content (e.g., between an episode of a show and movie, between a movie and user generated content, between a movie and a song, between an episode of a show and a book, or between an episode of a show and a social media article, as just a few examples).

### II. Example Architecture

### A. Content System

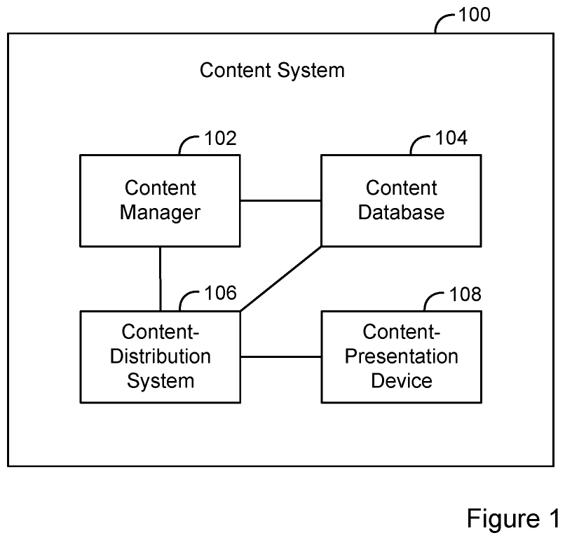

FIG. 1 is a simplified block diagram of an example content system 100. Generally, the content system 100 can perform operations related to various types of content, such as media content, which can take the form of video content and/or audio content. As such, the media content can include a video content component and/or an audio content component. There can be various types of media content. For example, media content can be, or include, a movie, a television show, a commercial, or a portion or combination thereof, among numerous other possibilities.

Media content can be represented by media data, which can be generated, stored, and/or organized in various ways and according to various formats and/or protocols, using any related techniques now known or later discovered. For example, the media content can be generated by using a camera, a microphone, and/or other equipment to capture or record a live-action event. In another example, the media content can be synthetically generated, such as by using any related media content generation technique (e.g., a generative AI-based technique) now known or later discovered.

As noted above, media data can also be stored and/or organized in various ways. For example, the media data can be stored and organized as a Multimedia Database Management System (MDMS) and/or in various digital file formats, such as the MPEG-4 format, among numerous other possibilities.

The media data can represent the media content by specifying various properties of the media content, such as video properties (e.g., luminance, brightness, and/or chrominance values), audio properties, and/or derivatives thereof. In some instances, the media data can be used to generate the represented media content. But in other instances, the media data can be a fingerprint or signature of the media content, which represents the media content and/or certain characteristics of the media content, and which can be used for various purposes (e.g., to identify the media content or characteristics thereof), but is not sufficient at least on its own to generate the represented media content.

In some instances, media content can include metadata associated with the video and/or audio content. In the case where the media content includes video content and audio content, the audio content is generally intended to be presented in sync with the video content. To help facilitate this, the media data can include metadata that associates portions of the video content with corresponding portions of the audio content. For example, the metadata can associate a given frame or frames of video content with a corresponding portion of audio content. In some cases, audio content can be organized into one or more different channels or tracks, each of which can be selectively turned on or off, or otherwise controlled. There can also be other types of metadata, such as those described throughout this disclosure.

In some instances, media content can be made up of one or more segments. For example, in the case where the media content is a movie, the media content may be made up of multiple segments, each representing a scene (or perhaps multiple scenes) of the movie. As another example, in the case where the media content is a television show, the media content may be made up of multiple segments, each representing a different act (or perhaps multiple acts) of the show. In various examples, a segment can be a smaller or larger portion of the media content. For instance, a segment can be a portion of one scene, or a portion of one act. In another example, a segment can be multiple scenes or multiple acts, or various portions thereof.

Returning back to the content system 100, this can include various components, such as: a content manager 102, a content database 104, a content-distribution system 106, and a content-presentation device 108. The content system 100 can also include one or more connection mechanisms that connect various components within the content system 100. For example, the content system 100 can include the connection mechanisms represented by lines connecting components of the content system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

In some instances, the content system 100 can include multiple instances of at least some of the described components. The content system 100 and/or components thereof can take the form of a computing system, an example of which is described below.

### B. Computing System

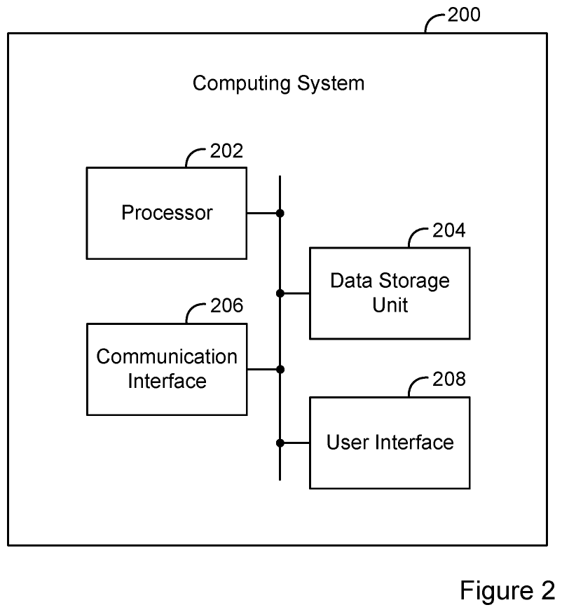

FIG. 2 is a simplified block diagram of an example computing system 200. The computing system 200 can be configured to perform and/or can perform various operations, such as the operations described in this disclosure. The computing system 200 can include various components, such as: a processor 202, a data storage unit 204, a communication interface 206, and/or a user interface 208.

The processor 202 can be, or include, a general-purpose processor (e.g., a microprocessor) and/or a special-purpose processor (e.g., a digital signal processor). The processor 202 can execute program instructions included in the data storage unit 204 as described below.

The data storage unit 204 can be or include one or more volatile, non-volatile, removable, and/or non-removable storage components, such as magnetic, optical, and/or flash storage, and/or can be integrated in whole or in part with the processor 202. Further, the data storage unit 204 can be, or include, a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or Wi-Fi interface.

The user interface 208 can allow for interaction between the computing system 200 and a user of the computing system 200. As such, the user interface 208 can be or include an input component such as: a keyboard, a mouse, a remote controller, a microphone, and/or a touch-sensitive panel. The user interface 208 can also be or include an output component such as a display device (which, for example, can be combined with a touch-sensitive panel) and/or a sound speaker.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, such as a partially or fully cloud-based arrangement, for instance.

As noted above, the content system 100 and/or components of the content system 100 can take the form of a computing system, such as the computing system 200. In some cases, some or all of these entities can take the form of a more specific type of computing system, such as: a desktop or workstation computer, a laptop, a tablet, a mobile phone, a television, a set-top box, a streaming media device, and/or a head-mountable display device (e.g., virtual-reality headset or an augmented-reality headset), among numerous other possibilities.

### III. Example Operations

The content system 100, the computing system 200, and/or components of either can be configured to perform and/or can perform various operations. As noted above, the content system 100 can perform operations related to media content. But the content system 100 can also perform other operations. Various example operations that the content system 100 can perform, and related features, will now be described with reference to select figures.

In one aspect, the content manager 102 can obtain media content from the content database 104 and can determine that one or more segments of the media content relate (i.e., contextually relate) to one or more other segments of the media content (or perhaps, of other media content). Then, for a given segment where it is determined that one or more other segments related to it, the content manager 102 can generate related segment metadata to indicate this, and store it in association with the given segment, such as in the content database 104.

After the related segment metadata has been generated and stored, the content system 100 (and/or components thereof, such as the content-presentation device 108) can perform one or more operations related to obtaining and outputting the related segment metadata. In one aspect, this can involve (i) proximate a time period during which a current segment of media content is output for presentation by the content-presentation device 108, the content-presentation device 108 detecting an occurrence of a trigger event; (ii) responsive to detecting the occurrence of the trigger event, the content-presentation device 108 obtaining related segment metadata associated with one or more related segments of media content that are separate from, but contextually related to, the current segment; and (iii) proximate a time point at which the trigger event occurred, the content-presentation device 108 causing the obtained related segment metadata to be output for presentation. These and related operations will now be described in greater detail.

### A. Determining Related Segments and Generating Related Segment Metadata

As noted above, the content manager 102 can determine that one or more segments of media content relate (i.e., contextually relate) to one or more other segments of media content. The content system 100 can do this in various ways. In one aspect, the content system 100 can analyze multiple segments of media content and/or associated data and based on that analysis, determine for each segment, which (if any) other segments are related to it.

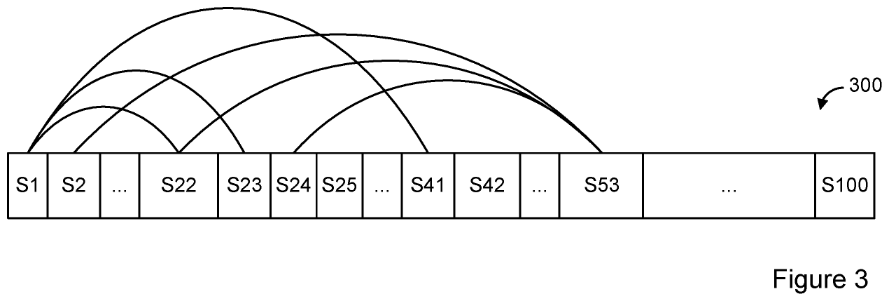

For the purposes of illustrating this and other related concepts, FIG. 3 depicts an example media content item 300, which consists of one hundred segments: S1, S2, S3 . . . S100, in that order. The media content item 300 could be a movie having one hundred scenes, for example. Within this context, in one example, for segment S1, the content system can determine that segment S22, S23, and S41 relate to it. In this case, the content manager 102 can generate related segment metadata for segment S1, where that related segment metadata identifies segments S22, S23, and S41 (e.g., by way of specifying certain metadata of those segments S22, S23, and S41). Such relatedness relationships are depicted in FIG. 3 with arced lines. As still another example, for segment S22 the content manager 102 can determine that segment S53 relates to it. As another example, for segment S22, the content manager 102 can determine that segments S1 and S53 relate to it. As still another example, for segment S53, the content manager 102 can determine that segments S2, S22, and S24 relate to it.

As noted above, the content manager 102 can analyze multiple segments of media content and/or associated data and based on that analysis, determine for each segment, which (if any) other segments are related to it. To do this, for a given segment, the content manager 102 can obtain data associated with that given segment, from the content database 104 or elsewhere, and which the content manager 102 can do in various ways. For example, for a given segment, the content manager 102 can (i) obtain closed-captioning text (e.g., which the content manager 102 can extract from metadata associated with the segment), (ii) subtitle text (e.g., which the content manager 102 can obtain by providing a video component of the segment to an optical character recognition (OCR) system and responsively receiving the subtitle text), (iii) dialogue text (e.g., which the content manager 102 can obtain by providing an audio component of the segment to a speech-to-text (STT) system and responsively receiving the dialogue text), (iv) a text description of an object (e.g., which content manager 102 can obtain by providing a video component of the segment to an object detection system and responsively receiving the text description of the object), (v) a text description of a segment (e.g., which content manager 102 can obtain by providing a video component of the segment to a semantic understanding/description system and responsively receiving the text description of the segment), and/or (vi) a face identifier (e.g., which content manager 102 can obtain by providing a video component of the segment to a facial recognition system and responsively receiving the face identifier), among numerous other possibilities. For these purposes, the content manager 102 can use any OCR system, STT system, object detection system, semantic understanding/description system, and/or facial recognition system now known or later discovered.

The content manager 102 can likewise repeat this process for one or more other segments (referred to herein as candidate related segments) of the media content (or other media content), such that the content manager 102 can compare and/or otherwise evaluate the respective sets of data to determine whether there is a sufficient extent of relatedness/similarity so as to deem the two segments related. In doing so, the content manager 102 can apply various predefined rules, weights, thresholds, etc. to determine whether there is a sufficient extent of relatedness/similarity. For example, a given pair of segments could be deemed related because they include one or more of the same characters, because they take place in the same settings, and/or because they involve dialogue that relates to a similar plot point, among numerous other possible reasons.

In some instances, based on the extent of relatedness/similarity between the data being compared, the content manager 102 can assign a relatedness score (e.g., a value within a range from 0-100) to indicate the extent of the similarity/relatedness. Among other things, this score can allow the content manager 102 to deem certain pairs of segments as being related, perhaps based on them being sufficiently related when compared to the extent of relatedness of other pairs of segments.

In some cases, the content manager 102 can be configured such that other parameters are considered when determining whether a given segment has any related segments. For instance, the content manager 102 can be configured such that for a given segment of a media content item, any related segments must also be from that same media content item. But in other examples, the content system 100 can be configured such that for a given segment of a media content item, any related segments can be from a different media content item, provided that the two media content items at issue are in the same series (e.g., where the media content items at issue are different episodes of a given television show, or where the media content items at issue are different movies in a series of movies). In the case where the two segments at issue are from the same media content item, the content manager 102 can be configured such that for a given segment of the media content item, any related segments must be earlier in time chronologically within the media content item. In practice, this can help ensure that for a given segment, any related segments are ones that were likely already presented/seen by the user.

In connection with this process, in some examples, the content manager 102 can use the data associated with a given segment to determine an extent of relevance (within the context of the media content item of which the segment is a part). In some examples, the determined extent of relevance can take the form of a relevance score (e.g., a value within a range from 0-100). In practice, this can help the content manager 102 distinguish between a segment that is likely to be considered by a user as highly relevant (e.g., a scene in a movie that relates to the core storyline of the movie) and a segment that is likely to be considered by the user as not very relevant (e.g., a scene in a movie that is more of a “filler” scene, unrelated to the core storyline).

In some examples, the content manager 102 can analyze at least some of the associated data described above to determine the extent of relevance. But the content manager 102 can also consider other data was well. For example, the content manager 102 can analyze social media content (e.g., where users are discussing a media content item or a specific segment thereof), chat transcripts associated contemporaneous/simultaneous viewing sessions for the media content item or segment at issue, a corresponding plot description summary provided by a website, viewer engagement data, and/or any other data that might help the content manager 102 determine the extent of relevance. Thus, for example, in the case where the content manager 102 determines that a segment includes certain dialogue text and that text is the subject of extensive social media discussion, this can cause the content manager 102 to assign a relatively high relevance score to that segment.

In connection with determining an extent of relevance for a segment, the content manager 102 can also consider other data was well. For example, the content segment can consider user profile data. For example, in the case where the content manager 102 determines that user profile data indicates the user has a preference for or interest in a certain actor/actress, the content manager 102 can use this as a basis to determine an extent of relevance of a given segment (based on whether or not the actor/actress is in that segment).

There can be various types of user profile data that can be obtained/determined in this context. For example, the user profile data can include demographic data that provides details about the user's age, gender, etc. As another example, the user profile data can include preference data that indicates content-related preferences for that user. For example, the preference data could include genre preference data that indicates one or more genre types (e.g., action, adventure, comedy, or romance) that the user prefers. As another example, as noted above, the preference data could include actor/actress preference data that indicates one or more actors or actresses that the user prefers. There can be many other types of preference data as well, including preference data related to any aspect of media (e.g., preferences related to plot types, writers, directors, settings, art styles, release dates, budgets, ratings, and/or reviews, among numbers possibilities).

Preference data can be represented in various ways. For instance, preference data can be represented with one or more scores (e.g., from 0-100) being assigned to each of multiple different potential preferences to indicate a degree or confidence score of each one, with 0 being the lowest and 100 being the highest, as just one example. For instance, in the case where the preference data indicates genre type preferences, the preference data could indicate a score of 96 for action, a score of 82 for adventure, a score of 3 for comedy, a score of 18 for romance, and so on. As such, the score of 96 for action can indicate that the user generally has a strong preference for media content of the action genre. Similarly, the score of 82 for adventure can indicate that the user also generally has a strong preference for media content of the adventure genre, though not quite as strong as a preference as compared to the action genre. And so on for each of the other genres.

There can be other types of user profile data as well. For example, user profile data can include media presentation history information of the user, among numerous other possibilities. In some instances, media presentation history information could indicate various user activity in connection with media and/or portions thereof. For example, user profile data could indicate which movies, television shows, or advertisements a user has watched, how often, etc. In another example, user profile data could indicate an extent to which the user has replayed or paused certain media, or a segment thereof, which might indicate a certain level of interest in that portion. In another example, user profile data can include an emotional response profile for that user.

In another example, user profile data can include annotations made by the user in connection with a given segment of media content. In one aspect, while a user is viewing media content via the content-presentation device 108, the user can use a user interface of the content-presentation device 108 to annotate the media content, such as by marking a specific temporal portion of the media content (e.g., with starting frame and ending frame markers) or by adding corresponding notes (e.g., by entering text, adding a voice-based note, etc.). This annotation data can then be stored as metadata and later obtained for use in connection with the relevancy analysis and/or for various other purposes.

Such user profile data can be obtained, stored, organized, and retrieved in various ways, such as by using any related user profile data technique now known or later discovered. In some instances, user profile data can be obtained, stored, and/or used only after the user has provided explicit permission for such operations to be performed. Likewise, in some cases, various other features and/or operations disclosed herein can be provided/performed only after the user has provided explicit permission to do so. Notably, user profile data can also be used to store user settings for various configurations (e.g., to enable or disable one or more features, such as those disclosed herein).

In some examples, the content manager 102 can determine related segments and then use the determined extent of relevance for those segments to filter and/or rank the results. But in other examples, the content manager 102 can integrate the relatedness and relevance analysis together, such that the extent of relevance is a consideration when determining whether a given segment is related to another segment.

In some examples, media content can be marked with segment markers (e.g., with starting and ending frames) such that the content manager 102 can identify the different segments within the media content. In other examples, the content system 100 can provide the media content to a segment detection system that can use various properties of the media content (e.g., detection of black frames, frame transition, etc.) to identify and mark various different segments within the media content. For this purpose, the content manager 102 can use any segment detection system now known or later discovered.

In some examples, the content manager 102 can determine that a given segment is related to another segment, and/or can determine an extent of relevance for the given segment by employing a machine learning technique, such as one that uses a deep neural network (DNN) to train an analysis model to use appropriate input data and output data. For example, the model can be trained to use a runtime input data set that includes data associated with multiple segments (such as any of the data described above), to generate a runtime output data set that includes an indication of which segment(s) relate to which other segment(s), and for any such pair, a corresponding relatedness score (such as in the form of related segment metadata), and for any given segment, a corresponding extent of relevance (such as in the form of a relevance score).

Various different types of models could be used for this purpose, including for example, models that employ a two stream convolutional neural network (CNN), multi-stream CNN, 3D CNN, or multi-stream 3D CNN architecture, or any other suitable architectures now known or later discovered. Regardless of the employed model, before the content manager 102 uses a model for this purpose, the content system 100 can first train the model by providing it with training input data sets and training output data sets that parallel the runtime data sets described above, in a training phase.

In practice, it is likely that large amounts of training data-perhaps thousands of training data sets or more-would be used to train the model as this generally helps improve the usefulness of the model. Training data can be generated in various ways, including by being manually assembled. However, in some cases, the one or more tools or techniques, including any training data gathering or organization techniques now known or later discovered, can be used to help automate or at least partially automate the process of assembling training data and/or training the model. For these purposes, the content manager 102 can use any machine learning technique, DNN, and/or model now known or later discovered.

Although some of the operations described herein have been described in connection with a given segment, the content manager 102 can repeat some or all of processes described herein for other segments as well, so that the content manager can determine all appropriate segments and store all appropriate related segment metadata.

In connection with the content system 100 determining related segments and associated data, the content system 100 can generate and/or update one or more corresponding graphs representing this information, in a graph database or a similar type of database (e.g., in the data storage unit 204) that stores such information. The content system 100 (and/or components thereof) can also create a new set of metadata (and related schema) needed to build and enhance such knowledge/relationship graphs.

### B. Detecting an Occurrence of a Trigger Event

After the related segment metadata has been generated and stored, the content system 100 (and/or components thereof, such as the content-presentation device 108) can perform one or more operations related to obtaining and outputting related segment metadata for a current segment (i.e., for a segment that the user is currently viewing, or that the user is about to view or has recently viewed). To facilitate this, in one aspect, proximate (i.e., during or near) a time period during which a current segment of media content is output for presentation by the content-presentation device 108, the content-presentation device 108 can detect an occurrence of a trigger event. There can be various different types of trigger events to suit a desired configuration.

For example, the content-presentation device 108 detecting an occurrence of a trigger event can involve the content-presentation device 108 detecting that the content-presentation device has paused output of media content. In this way, a user pausing the media content can cause the content-presentation device 108 to perform certain operations to facilitate outputting related segment metadata to the user.

In another example, the content-presentation device 108 detecting an occurrence of a trigger event can involve the content-presentation device 108 detecting presence of a marker within current segment metadata associated with the current segment. Such a marker can be an annotation added by a user or by the content manager 102, perhaps based on the content manager 102 determining that the marked location represents a portion of the media content in which a user is likely to want to be provided with related segment metadata. In practice, the content manager 102 could add a marker to a section of media content that is a major plot point and/or that may be likely to warrant special attention (based on the content manager 102 determining this from an analysis of social media discussion, for example).

In other examples, other trigger conditions could be used as well, such as trigger conditions related to the content-presentation device 108 detecting various types of user behavior, emotional responses to presented content, etc.

### C. Obtaining Related Segment Metadata

Responsive to detecting the occurrence of the trigger event, the content-presentation device 108 can obtain related segment metadata associated with one or more related segments of media content that are separate from, but contextually related to, the current segment. The content-presentation device 108 can obtain related segment metadata associated with one or more related segments of media content in various ways. For example, this can involve the content-presentation device 108 (i) obtaining current segment metadata associated with the current segment, wherein the current segment metadata includes a related segment data component that identifies related segment metadata associated with the one or more related segments; and (ii) using the related segment data component to obtain the related segment metadata. The related segment metadata can be generated and/or stored in various ways, such as those described above. In some cases, the content-presentation device 108 can use information such as relatedness scores to rank and/or filter such results.

### D. Outputting the Related Segment Metadata

Next, proximate (i.e., at or near) a time point at which the trigger event occurred, the content-presentation device 108 can cause the obtained related segment metadata to be output for presentation. In one example, this can involve causing the content-presentation device 108 to output the obtained related segment metadata for presentation, perhaps as a pop-up or overlay over the paused media content. But in other examples, this can involve causing a second device (e.g., a “second screen” device, such as user's mobile phone, tablet, or laptop) that is separate from the content-presentation device to output the obtained related segment metadata for presentation. The content-presentation device 108 can cause such a separate device in output the obtained related segment metadata for presentation in various ways, such as by sending a suitable instruction to the second device or to the content-distribution system 106 (which in turn, can forward the instruction to the second device), for example. In other examples, a separate server may facilitate causing the second device to perform such operations.

The obtained related segment metadata can include various components and can be presented in various ways. For example, the obtained related segment metadata can include a link to media data representing at least one of the one or more related segments, a text-based summary of at least one of the one or more related segments (which might include a text-based description of a scene, an object, and or a character), and/or an image of an object or character included in at least one of the one or more related segments, among numerous other possibilities. In some examples, the related segment metadata can be presented in a grid-like fashion, with each row corresponding to a different related segment.

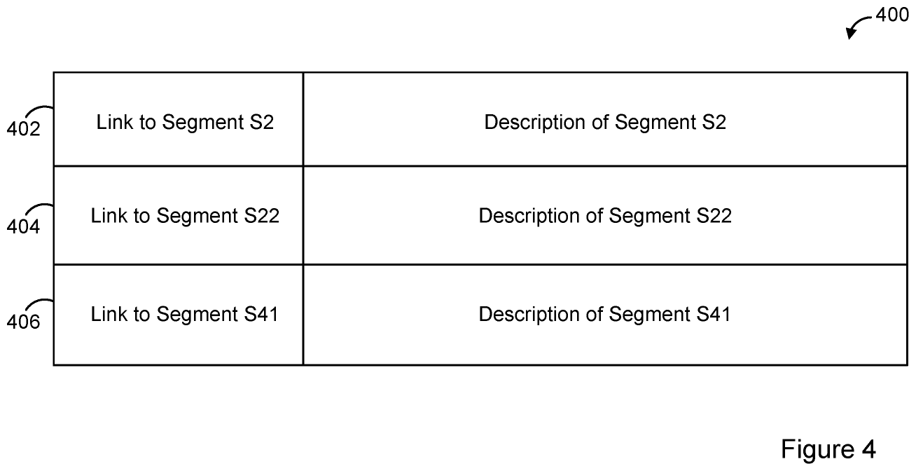

Thus, for example, returning to the example media content item 300 depicted in FIG. 3, in the case where the current segment is S53 and where the related segment metadata indicates that segments S2, S22, and S24 are related to S53, as shown in FIG. 4, the content-presentation device 108 can output a grid 400 that includes three rows, 402, 404, and 406. Row 402 corresponds to related segment S2, and includes a link (e.g., in the firm of a URL) to segment S1 and a text-based description of segment S1. Similarly, row 404 corresponds to related segment S22, and includes similar types of information for segment S22, and row 406 corresponds to related segment S41, and includes similar types of information for segment S41. It should be noted that the grid 400 is just one basic example way in which the related segment metadata can be presented. In practice, the metadata can be arranged in various different ways and include more or less information. For instance, in connection with a given segment, the output can include an image of a character appearing in the segment, a start time of the segment, an end time of the segment, and/or a duration of the segment, among numerous other possibilities. Other types of data can be output as well, such as user-provided annotations, for example.

In the case where the related segment metadata includes a link to a segment, the content-presentation device 108 can select the link (e.g., based on input received via a user interface, the link), and responsive to selecting the link, the content-presentation device 108 can cause the linked related segment to be output for presentation. The content-presentation device 108 can do this in various ways, such as by transmitting a suitable request to the content-distribution system 106, which can cause the content-distribution system 106 to transmit the segment to the content-presentation device 108, such that it can be output for presentation. In practice, this can allow a user to pause media content output while watching a current segment, and then be provided with related segment metadata for one or more related segments, such that the user can select an appropriate link and easily view the related segments, perhaps in preparation for watching, rewatching, and/or resuming the current segment.

### E. Example Methods

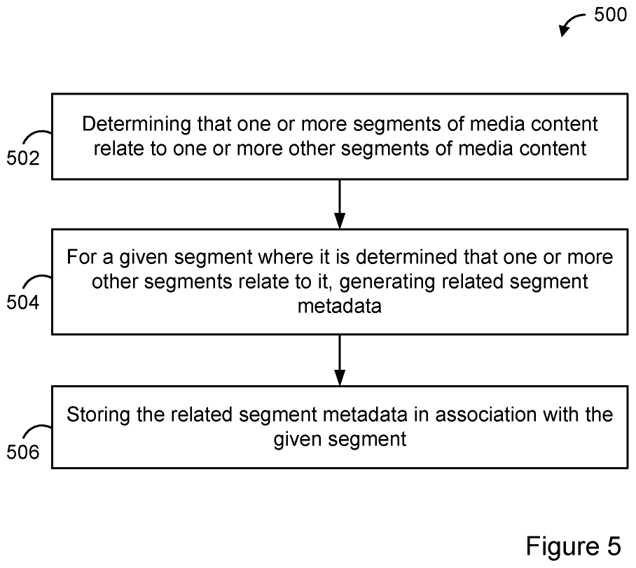

FIG. 5 is a flow chart illustrating an example method 500. The method 500 can be carried out by a content manager, such as the content manager 102, or more generally, by a computing system, such as the computing system 200. At block 502, the method 500 includes determining that one or more segments of media content relate to one or more other segments of media content. At block 504, the method 500 includes for a given segment where it is determined that one or more other segments relate to it, generating related segment metadata. At block 506, the method 500 includes storing the related segment metadata in association with the given segment.

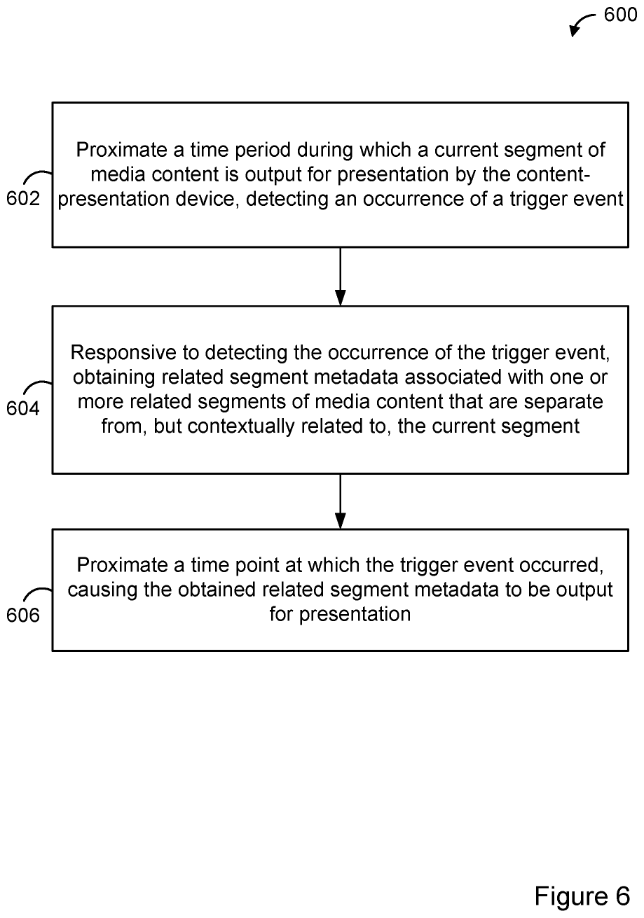

FIG. 6 is a flow chart illustrating an example method 600. The method 500 can be carried out by a content-presentation device, such as the content-presentation device 108, or more generally, by a computing system, such as the computing system 200. At block 602, the method 600 includes proximate a time period during which a current segment of media content is output for presentation by the content-presentation device, detecting an occurrence of a trigger event. At block 604, the method 600 includes responsive to detecting the occurrence of the trigger event, obtaining related segment metadata associated with one or more related segments of media content that are separate from, but contextually related to, the current segment. At block 606, the method 600 includes proximate a time point at which the trigger event occurred, causing the obtained related segment metadata to be output for presentation.

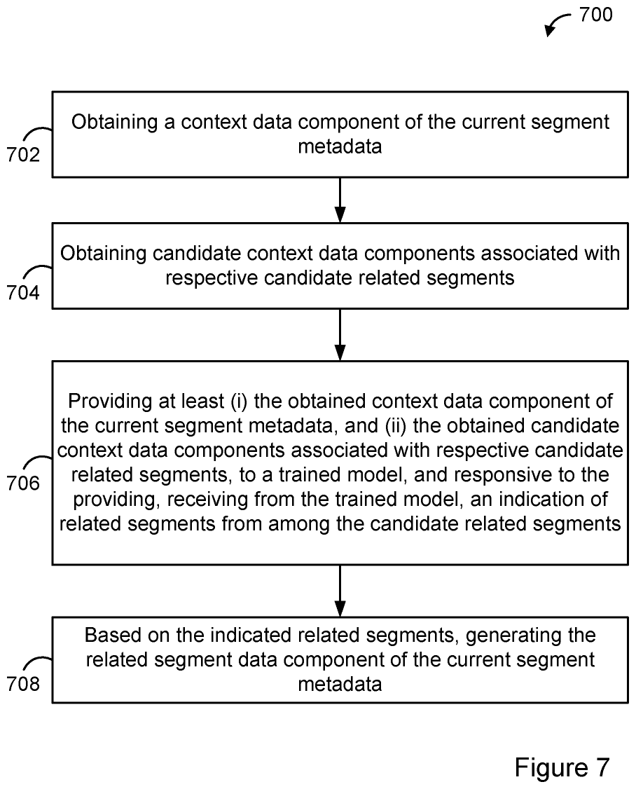

FIG. 7 is a flow chart illustrating an example method 700. The method 700 can be carried out by a content-presentation device, such as the content-presentation device 108, or more generally, by a computing system, such as the computing system 200. At block 702, the method 700 includes obtaining a context data component of the current segment metadata. At block 704, the method 700 includes obtaining candidate context data components associated with respective candidate related segments. At block 706, the method 700 includes providing at least (i) the obtained context data component of the current segment metadata, and (ii) the obtained candidate context data components associated with respective candidate related segments, to a trained model, and responsive to the providing, receiving from the trained model, an indication of related segments from among the candidate related segments. At block 708, the method 700 includes based on the indicated related segments, generating the related segment data component of the current segment metadata

In various examples, detecting an occurrence of a trigger event involves (i) detecting that the content-presentation device has paused output of media content, and/or (ii) detecting presence of a marker within current segment metadata associated with the current segment.

In various examples, obtaining related segment metadata associated with one or more related segments of media content that are separate from, but contextually related to, the current segment involves: (i) obtaining current segment metadata associated with the current segment, wherein the current segment metadata includes a related segment data component that identifies related segment metadata associated with the one or more related segments; and (ii) using the related segment data component to obtain the related segment metadata.

In various examples, the method 500 further includes generating a related segment data component of current segment metadata associated with the current segment, wherein generating the related segment data component of the current segment metadata involves: (i) obtaining a context data component of the current segment metadata; (ii) obtaining candidate context data components associated with respective candidate related segments; (iii) providing at least (a) the obtained context data component of the current segment metadata, and (b) the obtained candidate context data components associated with respective candidate related segments, to a trained model, and responsive to the providing, receiving from the trained model, an indication of related segments from among the candidate related segments; and (iv) based on the indicated related segments, generating the related segment data component of the current segment metadata.

In various examples, the obtained context data component of the current segment metadata includes (i) closed-captioning text, (ii) subtitle text, (iii) dialogue text generated from a speech-to-text system, (iv) text generated from a video-to-text system, (v) a text description of an object identified by an object detection system, or (vi) a face identifier generated by a facial recognition system.

In various examples, the providing further comprises providing (i) user profile data for a user of the content-presentation device, (ii) social media data associated with media content of which the current segment is a part, or (iii) chat data associated with media content of which the current segment is a part, to the trained model.

In various examples, the method 500 further includes training the model by providing to the model, (i) multiple instances of segment metadata, and (ii) indications of which instances of segment metadata relate to other instances of segment metadata.

In various examples, causing the obtained related segment metadata to be output for presentation involves causing the content-presentation device to output for presentation the obtained related segment metadata.

In various examples, causing the obtained related segment metadata to be output for presentation involves causing a second device that is separate from the content-presentation device to output for presentation the obtained related segment metadata.

In various examples the obtained related segment metadata includes a link to media data representing at least one of the one or more related segments, and the method 500 further involves: selecting, based on input received via a user interface, the link; and responsive to selecting the link, causing the linked related segment to be output for presentation.

In various examples, the obtained segment metadata includes (i) a text-based summary of at least one of the one or more related segments, and/or (ii) an image of a character included in at least one of the one or more related segments.

In various examples, the current segment and the related one or more segments are part of a given media content movie or show series, and wherein the related one or more segments precede the current segment, according to a standard playout chronology of the media content movie or show series.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
proximate a time period during which a current segment of media content is output for presentation by a content-presentation device, detecting an occurrence of a trigger event;
responsive to detecting the occurrence of the trigger event, obtaining related segment metadata associated with one or more related segments of media content that are separate from, but contextually related to, the current segment; and
proximate a time point at which the trigger event occurred, causing the obtained related segment metadata to be output for presentation.

2. The method of claim 1, wherein detecting an occurrence of a trigger event comprises detecting that the content-presentation device has paused output of media content.

3. The method of claim 1, wherein detecting an occurrence of a trigger event comprises detecting presence of a marker within current segment metadata associated with the current segment.

4. The method of claim 1, wherein obtaining related segment metadata associated with one or more related segments of media content that are separate from, but contextually related to, the current segment comprises:
obtaining current segment metadata associated with the current segment, wherein the current segment metadata includes a related segment data component that identifies related segment metadata associated with the one or more related segments; and
using the related segment data component to obtain the related segment metadata.

5. The method of claim 1, further comprising generating a related segment data component of current segment metadata associated with the current segment, wherein generating the related segment data component of the current segment metadata comprises:
obtaining a context data component of the current segment metadata;
obtaining candidate context data components associated with respective candidate related segments;
providing at least (i) the obtained context data component of the current segment metadata, and (ii) the obtained candidate context data components associated with respective candidate related segments, to a trained model, and responsive to the providing, receiving from the trained model, an indication of related segments from among the candidate related segments; and
based on the indicated related segments, generating the related segment data component of the current segment metadata.

6. The method of claim 5, wherein the obtained context data component of the current segment metadata includes (i) closed-captioning text, (ii) subtitle text, (iii) dialogue text generated from a speech-to-text system, (iv) text generated from a video-to-text system, (v) a text description of an object identified by an object detection system, or (vi) a face identifier generated by a facial recognition system.

7. The method of claim 5, wherein the providing further comprises providing (i) user profile data for a user of the content-presentation device, (ii) social media data associated with media content of which the current segment is a part, or (iii) chat data associated with media content of which the current segment is a part, to the trained model.

8. The method of claim 5, further comprising training the model by providing to the model, (i) multiple instances of segment metadata, and (ii) indications of which instances of segment metadata relate to other instances of segment metadata.

9. The method of claim 1, wherein causing the obtained related segment metadata to be output for presentation comprises causing the content-presentation device to output for presentation the obtained related segment metadata.

10. The method of claim 1, wherein causing the obtained related segment metadata to be output for presentation comprises causing a second device that is separate from the content-presentation device to output for presentation the obtained related segment metadata.

11. The method of claim 1, wherein the obtained related segment metadata comprises a link to media data representing at least one of the one or more related segments, the method further comprising:
selecting, based on input received via a user interface, the link; and
responsive to selecting the link, causing the linked related segment to be output for presentation.

12. The method of claim 1, wherein the obtained segment metadata comprises a text-based summary of at least one of the one or more related segments.

13. The method of claim 1, wherein the obtained segment metadata comprises an image of a character included in at least one of the one or more related segments.

14. The method of claim 1, wherein the current segment and the related one or more segments are part of a given media content movie or show series, and wherein the related one or more segments precede the current segment, according to a standard playout chronology of the media content movie or show series.

15. A computing system configured for performing a set of acts comprising:
proximate a time period during which a current segment of media content is output for presentation by a content-presentation device, detecting an occurrence of a trigger event;
responsive to detecting the occurrence of the trigger event, obtaining related segment metadata associated with one or more related segments of media content that are separate from, but contextually related to, the current segment; and
proximate a time point at which the trigger event occurred, causing the obtained related segment metadata to be output for presentation.

16. The computing system of claim 15, wherein detecting an occurrence of a trigger event comprises detecting that the content-presentation device has paused output of media content.

17. The computing system of claim 15, wherein detecting an occurrence of a trigger event comprises detecting presence of a marker within current segment metadata associated with the current segment.

18. The computing system of claim 15, wherein obtaining related segment metadata associated with one or more related segments of media content that are separate from, but contextually related to, the current segment comprises:
obtaining current segment metadata associated with the current segment, wherein the current segment metadata includes a related segment data component that identifies related segment metadata associated with the one or more related segments; and
using the related segment data component to obtain the related segment metadata.

19. The computing system of claim 15, the set of acts further comprising generating a related segment data component of current segment metadata associated with the current segment, wherein generating the related segment data component of the current segment metadata comprises:
obtaining a context data component of the current segment metadata;
obtaining candidate context data components associated with respective candidate related segments;
providing at least (i) the obtained context data component of the current segment metadata, and (ii) the obtained candidate context data components associated with respective candidate related segments, to a trained model, and responsive to the providing, receiving from the trained model, an indication of related segments from among the candidate related segments; and
based on the indicated related segments, generating the related segment data component of the current segment metadata.

20. A non-transitory computer-readable medium having stored thereon program instructions that upon execution by a processor, cause performance of a set of acts comprising:
proximate a time period during which a current segment of media content is output for presentation by a content-presentation device, detecting an occurrence of a trigger event;
responsive to detecting the occurrence of the trigger event, obtaining related segment metadata associated with one or more related segments of media content that are separate from, but contextually related to, the current segment; and
proximate a time point at which the trigger event occurred, causing the obtained related segment metadata to be output for presentation.
